(19) United States
(12) Patent Application Publication
(10) Pub. No.: US 2011/0132190 A1
(43) Pub. Date: Jun. 9, 2011

(54) PISTON MACHINE FOR USE AS A VACUUM PUMP FOR MEDICAL PURPOSES

(75) Inventor: Guido Koch, Karlsruhe (DE)

(73) Assignee: Maquet GmbH & Co. KG, Rastatt (DE)

(21) Appl. No.: 12/948,833

(22) Filed: Nov. 18, 2010

(30) Foreign Application Priority Data
Dec. 4, 2009 (DE) 10 2009 057 070.5

(51) Int. Cl. F01B 31/26; F16J 10/02

(52) U.S. Cl. 92/169.3; 92/165 R

(57) ABSTRACT

The invention relates to a piston machine (10, 40) which comprises at least a cylinder (12a, 12b) and a cylinder head (18a, 18b) closing an opening of the cylinder (12a, 12b). Further, the piston machine (10, 40) has a piston (22a, 22b) arranged, at least in part, within the cylinder (12a, 12b) and arranged movably in its longitudinal direction with the aid of a connecting rod (28a, 28b). The piston (22a, 22b) has an opening extending in its longitudinal direction, within which at least a partial area of a guiding element (30a, 30b) firmly connected to the cylinder head (18a, 18b) is arranged.

### CROSS REFERENCE TO RELATED APPLICATIONS

Applicant hereby claims foreign priority benefits under U.S.C. §119 from German Patent Application No. 10 2009 057 070.5 filed on Dec. 4, 2009, the contents of which are incorporated by reference herein.

### TECHNICAL FIELD

The invention relates to a piston machine having at least one cylinder and a cylinder head closing an opening of the cylinder. Further, the piston machine comprises a piston arranged, at least in part, within the cylinder and arranged movably in its longitudinal direction relative to the cylinder and relative to the cylinder head with the aid of a connecting rod.

### BACKGROUND OF THE INVENTION

A common type of piston guidance is the so-called plunger guidance where the piston is directly connected to the crankshaft via the connecting rod. The transverse forces exerted on the piston due to the inclination of the connecting rod are absorbed by the cylinder wall by which the piston is guided. These transverse forces try to tilt the piston, which, on the one hand, results in a development of noise and, on the other hand, can cause jamming of the piston. In particular, in vacuum pumps for medical use, such a development of noise can be found very annoying. In order to prevent jamming, the piston has to be designed relatively long compared to its diameter, this resulting in a relatively large size of the cylinder and a high oscillating mass. On the other hand, the gap between the piston and the cylinder wall has to be dimensioned so large that the piston can expand as a result of the heat developed during operation of the piston machine. This necessary large gap promotes the development of noise as the piston, in an upper and a lower final position during its movement, each time changes from one abutting side to another abutting side as a result of a reversal of load.

A further common type of piston guidance is the so-called crosshead guidance where the piston is connected via a piston rod to a crosshead guided on a slide bearing. The crosshead in turn is connected to the crankshaft via the connecting rod. The slide bearing absorbs the transverse forces transmitted via the connecting rod from the crankshaft so that the piston only experiences forces in its longitudinal direction, and no forces are transmitted from the piston to the cylinder wall. What is disadvantageous with the crosshead guidance is that it requires a large installation space and presents a large oscillating mass. Thus, the crosshead guidance only comes into consideration for large machines with very low speeds of rotation.

From the document DE 2 001 921 A1, a liquid dispensing pump is known in which a piston is placed slidably over a valve shaft.

### SUMMARY OF THE INVENTION

It is the object of the invention to specify a piston machine which has a compact structure and a low noise level and in which no or only small transverse forces are transmitted from the piston onto the cylinder.

This object is solved by a piston machine having the features of claim 1. Advantageous developments are specified in the dependent claims.

By providing a guiding element which is firmly connected to the cylinder head and of which at least a partial area is arranged within an opening of the piston extending in longitudinal direction thereof, it is achieved that transverse forces exerted by the connecting rod on the piston are absorbed by the guiding element and are not transmitted to the cylinder wall, such as in the case of the plunger guidance. As the size of the opening of the piston expands together with the piston when the piston is heated during operation of the piston machine, the gap between the guiding element and the piston can be designed very small so that a tilting of the piston is prevented or the piston can only tilt minimally. As a result thereof, the development of noise during operation of the piston machine is reduced and a jamming of the piston is prevented easily. By guiding the piston with the aid of the guiding element, a favorable, i.e. as large as possible guiding ratio is achieved, compared to the plunger guidance, the guiding ratio being the ratio of the length of the piston to the diameter of the element guiding the piston. As no or only small forces are transmitted between the piston and the cylinder wall, the wear on the piston and/or the wear on the cylinder inner wall are reduced.

By means of the opening, in particular an inwardly directed sliding surface is formed. The piston preferably slides via this sliding surface on the guiding element.

The longitudinal direction is the direction in which the longitudinal axis of the piston is directed, i.e. the direction in which the piston moves, when it reciprocates in the cylinder during operation of the piston machine. What is meant by a tilting of the piston is when the longitudinal axis of the piston pivots relative to the longitudinal axis of the cylinder and thus the longitudinal axis of the cylinder and the longitudinal axis of the piston do no longer coincide. The cylinder and the cylinder head are preferably formed in one piece, as a result whereof the stability of the piston machine is increased. It is likewise advantageous when the guiding element and the cylinder head are formed in one piece, as a result whereof a reliable mounting of the guiding element on the cylinder head is achieved.

The transverse forces are all those forces that do not act in longitudinal direction of the piston. The transverse forces acting on the piston arise in particular from the rotation of a crankshaft connected to the piston via the connecting rod. The reciprocating movement of the piston within the cylinder is caused via the crankshaft and the connecting rod.

The play between the piston and the guiding element is in particular formed so little that the passage of a medium between the piston and the guiding element is prevented or the extent of passage of medium between the piston and the guiding element is so little that it can be neglected during operation of the piston machine. Hereby it is achieved that a sealing element for sealing the gap between the piston and the guiding element can be dispensed with. Further, as a result of the little play a tilting of the piston is prevented and a reliable guidance of the piston on the guiding element is achieved. The medium is, in particular, a gas, a liquid or a mixture of a gas and a liquid.

The opening of the piston and the guiding element are each preferably formed cylindrically so that a reliable guidance of the piston on the guiding element is achieved and a jamming of the piston is prevented. Alternatively, the guiding element and the opening can also have an arbitrary non-cylindrical cross-section.

It is advantageous when the opening is a bore and when the radius of the guiding element has a value between 98% and 99.9% of the radius of the bore. Hereby it is achieved that a sealing element between the piston and the guiding element can be dispensed with and a tilting of the piston and thus a development of noise are prevented.

When moved in longitudinal direction, the piston preferably slides on the guiding element so that the piston is always guided by means of the guiding element and a tilting is prevented.

It is advantageous when in all operating states during operation of the piston machine at least a partial area of the guiding element is arranged within the opening each time. Hereby it is achieved that the piston is guided in all operating states by the guiding element, and in all operating states the transverse forces acting on the piston are absorbed by the guiding element.

Further, it is advantageous when the longitudinal axis of the opening and the longitudinal axis of the piston coincide so that the opening is centered in the piston. In this way, it is achieved that the distance of the guiding element to the inside surface of the cylinder is the same in all directions and thus no tilting moment is generated as a result of different pressures exerted on the front surfaces of the piston.

The opening is in particular a through hole so that, also when the piston reciprocates, the piston is guided over a relatively long distance in its longitudinal direction by the guiding element passing through the through hole. The guiding element is, in particular, formed so long that it completely passes through the through hole in each operating state of the piston machine.

In an alternative embodiment of the invention, in particular in the case of piston machines in which the piston is only moved over short distances, the opening can also be formed as a blind hole. In this case, the length by which the guiding element projects into the bore varies dependent on the position of the piston.

In an alternative embodiment of the invention, the piston can comprise a sealing element projecting into the bore, which sealing element reduces, preferably prevents the passage of the medium into the piston via the guiding element. In this way, a sealing of the working chamber of the piston machine is achieved and thus the efficiency of the piston machine is increased.

The cylinder, the guiding element and the piston are in particular dimensioned such that even at the maximum allowable operating temperature of the piston machine, the piston does not contact the inside surface of the cylinder during movement in longitudinal direction. By preventing the contact between the piston and the inside surface of the cylinder, on the one hand, the jamming of the piston as well as the wear on the piston and cylinder are prevented. On the other hand, noises are prevented which, in the case of known plunger machines, are caused by the change of the abutting side of the piston on the inside surface of the cylinder.

It is advantageous when the piston comprises a sealing element which is firmly connected to the piston, contacts the inside surface of the cylinder and reduces the passage of the medium between the inside surface of the cylinder and the piston. It is particularly advantageous when the sealing element completely prevents the passage of the medium. Hereby, the efficiency of the piston machine is increased.

The piston machine is in particular a piston work machine, preferably a piston pump. By means of the reciprocating movement of the piston, the medium to be pumped is pumped from one place to another place. The piston pump is in particular a vacuum pump for the medical field or a liquid pump. The piston work machine can also be a compressor. Alternatively, the described piston guidance can also be used for piston engines. In particular, the piston guidance can be used in combustion engines, hydraulic and gas drives.

In a preferred embodiment of the invention, the piston machine comprises two cylinders, in each of which a piston having a bore extending in longitudinal direction is arranged, which piston can be moved relative to the cylinder. Each of the pistons is guided over a guiding element which is firmly connected to a cylinder head of the respective cylinder and is arranged, at least in part, within the bore of the respective piston. By providing several cylinders, the output of the piston machine is increased. In the case of a pump, the pumping capacity is increased by providing several cylinders.

### BRIEF DESCRIPTION OF THE DRAWINGS

Further features and advantages of the invention result from the following description which in connection with the enclosed figures explains the invention in more detail with reference to embodiments.

FIG. 1 shows a schematic perspective partially sectional illustration of a piston pump according to a first embodiment of the invention.

FIG. 2 shows a schematic perspective partially sectional illustration of a piston pump according to a second embodiment of the invention.

### DETAILED DESCRIPTION OF THE PREFERRED EMBODIMENT

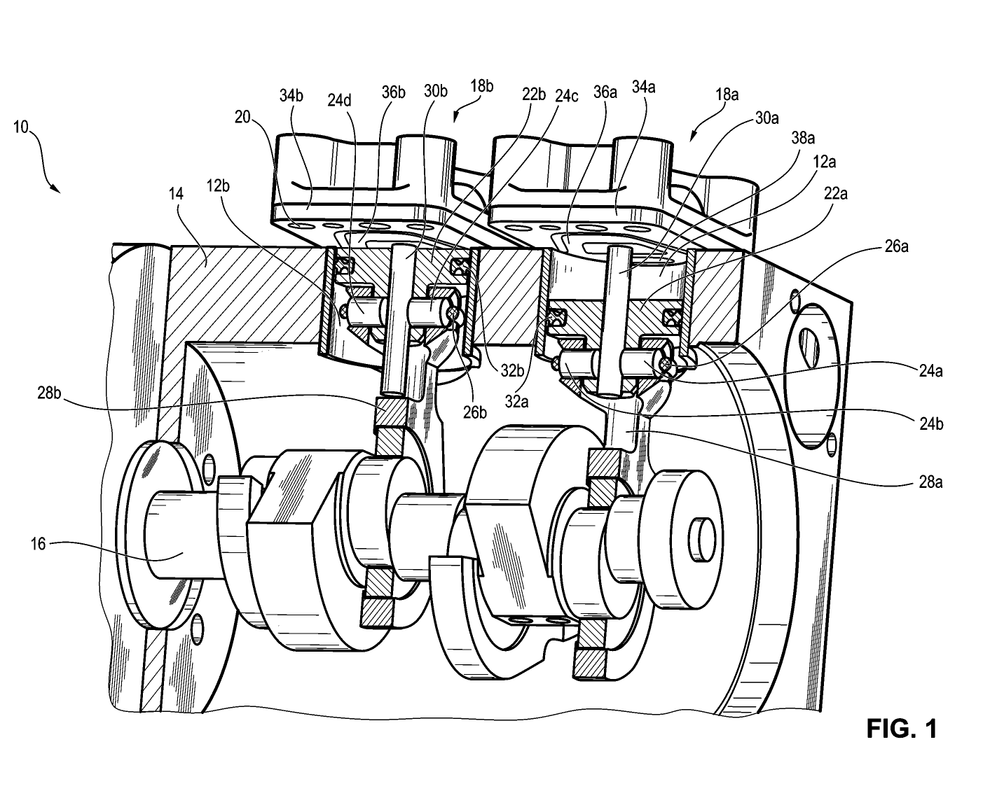

In FIG. 1, a schematic perspective partially sectional illustration of a piston pump 10 according to a first embodiment of the invention is shown. The piston pump 10 comprises two cylinders 12a, 12b which are formed such that they are integrated in a housing 14 of a crankshaft 16. Each of the cylinders 12a, 12b has two openings, of which the openings facing away from the crankshaft 16 are each closed with the aid of a cylinder head 18a, 18b. The openings 18a, 18b of the cylinders 12a, 12b facing the crankshaft 16 are not closed. The cylinder heads 18a, 18b are in particular each fixed to the housing 14 via several screws. For this, each of the cylinder heads 18a, 18b has several bores, of which one is exemplarily identified with the reference sign 20 in FIG. 1. In an alternative embodiment of the invention, the cylinders 12a, 12b and the cylinder heads 18a, 18b can also be formed in one piece.

Further, the piston pump 10 comprises two pistons 22a, 22b, of which one each is arranged, at least in part, within one of the cylinders 12a, 12b. Each of the pistons 22a, 22b is articulated via two bolts 24a to 24d to one connecting rod 28a, 28b each. The bolts 24a to 24d are secured against accidental slipping out with the aid of locking rings 26a, 26b. In an alternative embodiment of the invention, each of the connecting rods 28a, 28b can also be connected to the respective piston 22a, 22b by only one safety bolt 24a to 24d or more than two safety bolts 24a to 24d.

The ends of the connecting rods 28a, 28b facing away from the pistons 22a, 22b are connected to the crankshaft 16. The crankshaft 16 is set in rotation with the aid of a motor not illustrated in FIG. 1. By the rotary motion of the crankshaft 16, the connecting rods 28a, 28b are set in motion, as a result whereof the pistons 22a, 22b connected to the connecting rods 28a, 28b are moved back and forth in longitudinal direction within the cylinders 12a, 12b. The longitudinal direction is the direction in which the axial center axis of the pistons 22a, 22b and thus the longitudinal axis of the cylinders 12a, 12b extends. During reciprocation of the pistons 22a, 22b by means of the connecting rods 28a, 28b, the connecting rods 28a, 28b transmit both forces acting in longitudinal direction, which forces are responsible for the reciprocation of the pistons 22a, 22b, and forces acting transversely to the longitudinal direction on the pistons 22a, 22b.

The pistons 22a, 22b each have a through bore extending in longitudinal direction, the center axis of the through bore and the longitudinal axis of the pistons 22a, 22b each time coincide. In their reciprocating movement, the pistons 22a, 22b are each guided by a guiding element 30a, 30b formed complementarily to the bores of the pistons 22a, 22b. The guiding elements 30a, 30b are each firmly connected to the respective cylinder head 18a, 18b. The guiding elements 30a, 30b are arranged such that independent of the operating position in which the respective piston 22a, 22b is arranged, at least a partial area of the respective guiding element 30a, 30b is arranged within the through bore of the respective piston 22a, 22b. In the embodiment shown in FIG. 1, the guiding elements 30a, 30b are formed as a rod having a cylindrical cross-section, which is why the guiding elements 30a, 30b are also referred to as guiding rods.

In an alternative embodiment of the invention, the guiding elements 30a, 30b as well as the openings of the pistons 22a, 22b in which the guiding elements 30a, 30b are arranged can also have a rectangular cross-section each time. Likewise, arbitrary other cross-sectional shapes are conceivable.

The forces directed by the connecting rods 28a, 28b on the pistons 22a, 22b transversely to the longitudinal direction are transmitted by the pistons 22a, 22b to the respective guiding element 30a, 30b so that the forces acting transversely to the longitudinal direction do not have to be transmitted by the pistons 22a, 22b to the respective inner wall of the respective cylinder 12a, 12b. The play between the piston 22a, 22b and the respective inner wall of the respective cylinder 12a, 12b can thus be designed so large that the piston 22a, 22b does not contact the inner wall of the cylinder 12a, 12b even at the maximum operating temperature of the piston pump 10 and thus the maximum thermal expansion. Hereby, a wear of the piston 22a, 22b and/or the inner wall is prevented. The necessary sealing between the piston 22a, 22b and the inner wall of the cylinder 12a, 12b, which sealing is required to prevent that the medium to be pumped passes between the piston 22a, 22b and the inner wall of the cylinder 12a, 12b, is achieved by a sealing element 32a, 32b. The sealing elements 32a, 32b are made of an elastic material and are in particular so elastic that they guarantee a reliable sealing independent of the play between the piston 22a, 22b and the inner wall of the cylinder 12a, 12b which varies due to the thermal expansion of the pistons 22a, 22b and the cylinders 12a, 12b and thus prevent the passage of the medium to be pumped. The sealing elements 32a, 32b are in particular firmly connected to the respective piston 22a, 22b and each of them contacts the inner wall of the cylinders 12a, 12b when the pistons 22a, 22b reciprocate. The sealing elements 32a, 32b can also be formed as piston rings.

The diameter of the guiding elements 30a, 30b is each time only slightly smaller than the diameter of the respective bores of the respective pistons 22a, 22b. Hereby it is achieved that between the guiding element 30a, 30b and the piston 22a, 22b only a little play is present each time. This has, on the one hand, the effect that a sealing element between the pistons 22a, 22b and the guiding elements 30a, 30b can be dispensed with, since, due to the little play and the long length of the bore, a passage between the guiding element 30a, 30b and the piston 22a, 22b of the medium to be pumped is prevented or the amount of the passing medium is so little that it is within a range that is acceptable for the operation of the piston pump. On the other hand, due to the little play between the guiding element 30a, 30b and the piston 22a, 22b it is achieved that the piston 22a, 22b, during reciprocation, is not or only minimally tilted with respect to its longitudinal axis by the transverse forces acting transversely to the longitudinal direction. Hereby it is in turn achieved that a jamming of the piston 22a, 22b within the cylinder 12a, 12b is prevented and the development of noise of the piston pump 10 is reduced. Specifically in the medical field, for example in the case of vacuum pumps, the development of noise by the piston pump 10 can be annoying so that such a reduction of the development of noise involves a considerable advantage.

The play between the piston 22a, 22b and the guiding element 30a, 30b is in particular so little that the piston 22a, 22b slides on the guiding element 30a, 30b in longitudinal direction during reciprocation, as a result whereof a reliable guidance of the respective piston 22a, 22b is achieved. As the radius of the bore of the pistons 22a, 22b increases given a heating of the pistons 22a, 22b during operation of the piston pump 10, the play between the piston 22a, 22b and the guiding element 30a, 30b can be designed particularly little since a jamming during operation is prevented by the enlargement of the play.

In an alternative embodiment of the invention, a respective sealing element can also be arranged between the guiding element 30a, 30b and the respective piston 22a, 22b, which sealing element prevents or reduces the passage between the piston 22a, 22b and the guiding element 30a, 30b of the medium to be pumped. Each sealing element is preferably firmly connected to the piston 22a, 22b, may, however, alternatively also be firmly connected to the respective guiding element 30a, 30b.

The cylinder heads 18a, 18b each comprise a membrane 34a, 34b, which each has two flaps 36a, 36b, 38a. When the pistons 22a, 22b are moved in the direction of the crankshaft 16, the respective first flap 36a, 36b of the respective cylinder head 18a, 18b is opened in the direction of the cylinder 12a, 12b so that the medium to be pumped can flow into the working chamber of the cylinder 12a, 12b through the opened opening. When a piston 22a, 22b is moved away from the crankshaft 16, the first flap 36a, 36b is closed and the second flap 38a is opened so that the medium to be pumped is pumped out of the working chamber of the cylinder 12a, 12b via the outlet channel that can be closed by the second flap 38a.

In an alternative embodiment of the invention, the device 10 can also be a piston engine, in particular a combustion engine or a Stirling engine, instead of a piston pump. In this case, the principle of operation of the device is reversed so that the crankshaft 16 is not driven by a motor but the crankshaft 16 is set in rotation by the reciprocation of the pistons 22a, 22b via the connecting rods 28a, 28b.

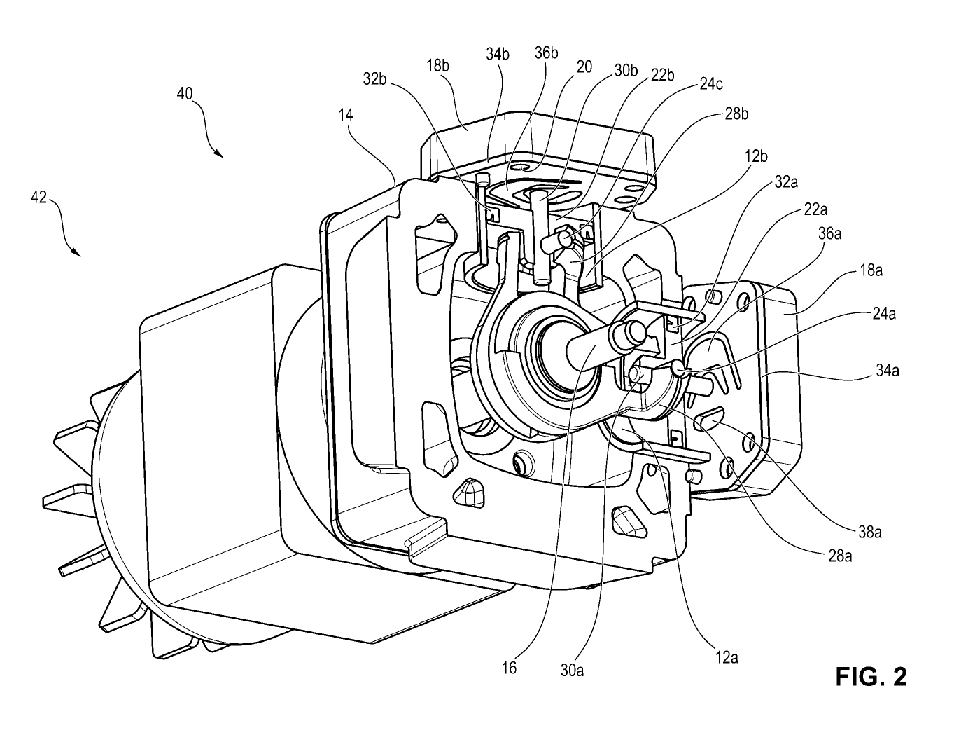

In FIG. 2, a schematic perspective partially sectional illustration of a piston pump 40 according to a second embodiment of the invention and a schematic perspective illustration of a motor 42 are shown. Elements having the same structure or the same function are identified by the same reference signs. The motor 42 is flanged to the piston pump 40 and serves to drive the crankshaft 16.

In contrast to the first embodiment shown in FIG. 1, the two cylinders 12a, 12b are not arranged in a row but offset by 90°. In an alternative embodiment of the invention, also more than two cylinders 12a, 12b or only one cylinder 12a, 12b can be provided. Alternatively, also several cylinders can be arranged in one row and in addition one cylinder or several cylinders can be arranged offset by an angle.

While the present invention has been illustrated and described with respect to a particular embodiment thereof, it should be appreciated by those of ordinary skill in the art that various modifications to this invention may be made without departing from the spirit and scope of the present.

What is claimed is:

1. A piston machine,
having at least one cylinder,
a cylinder head closing an opening of the cylinder, and
having a piston arranged, at least in part, within the cylinder and arranged movably in its longitudinal direction relative to the cylinder and the cylinder head with the aid of a connecting rod,
wherein the piston has an opening extending in its longitudinal direction, and
wherein at least a partial area of a guiding element firmly connected to the cylinder head is arranged within the opening of the piston.

2. The piston machine according to claim 1, wherein an inwardly directed sliding surface is formed by the opening.

3. The piston machine according to claim 1, wherein the guiding element absorbs at least a part, preferably all, of the forces acting on the piston transversely to the longitudinal direction of the piston during the movement of the piston in longitudinal direction.

4. The piston machine according to claim 1, wherein the play between the piston and the guiding element is so little that the passage of a medium between the piston and the guiding element is prevented.

5. The piston machine according to claim 1, wherein the guiding element is cylindrical.

6. The piston machine according to claim 1, wherein the piston, when moved in longitudinal direction, slides on the guiding element.

7. The piston machine according to claim 1, wherein in all operating states during operation of the piston machine at least a partial area of the guiding element is arranged within the opening each time.

8. The piston machine according to claim 1, wherein the longitudinal axis of the opening and the longitudinal axis of the piston coincide.

9. The piston machine according to claim 1, wherein the opening is a through bore.

10. The piston machine according to claim 1, wherein the piston comprises a sealing element projecting into the bore and reducing, preferably preventing the passage of a medium between the guiding element and the piston.

11. The piston machine according to claim 1, wherein the cylinder, the guiding element and the piston are dimensioned such that even given a maximum allowable operating temperature of the piston machine the piston does not contact the inside surface of the cylinder when the piston is moved in longitudinal direction.

12. The piston machine according to claim 1, wherein the piston comprises a sealing element which contacts the inside surface of the cylinder and reduces, preferably prevents, the passage of a medium between the inside surface of the cylinder and the piston.

13. The piston machine according to claim 1, wherein the piston machine is a piston work machine, preferably a piston pump, in particular a vacuum pump.

14. The piston machine according to claim 1, wherein the piston is connected via the connecting rod to a crankshaft.

15. The piston machine according to claim 1, wherein at least a further cylinder, a further cylinder head closing an opening of the further cylinder and a further piston are provided, which piston is arranged, at least in part, within the further cylinder and is arranged movably in its longitudinal direction relative to the further cylinder and relative to the further cylinder head with the aid of a further connecting rod, in that the further piston has an opening extending in its longitudinal direction, and in that at least a partial area of a further guiding element firmly connected to the further cylinder head is arranged within the opening of the further piston.
